(19) United States
(12) Patent Application Publication
(10) Pub. No.: US 2009/0024881 A1
(43) Pub. Date: Jan. 22, 2009

(54) SYSTEM AND METHOD FOR DEBT VALUATION

(75) Inventors: Joseph M. CARROLL, Waite Hill, OH (US); Francis A. CARROLL, Mentor, OH (US); Timothy M. NOVAK, Painesville, OH (US)

Correspondence Address: RENNER OTTO BOISSELLE & SKLAR, LLP, 1621 EUCLID AVENUE, NINETEENTH FLOOR, CLEVELAND, OH, 44115, US

(73) Assignee: HUDSON & KEYSE, L.L.C., Painesville, OH (US)

(21) Appl. No.: 12/170,695

(22) Filed: Jul. 10, 2008

Related U.S. Application Data
(60) Provisional application No. 60/950,463, filed on Jul. 18, 2007.

(51) Int. Cl. G06Q 40/00; G06F 9/44; H04L 9/32; G06F 11/07

(52) U.S. Cl. 714/57; 705/36 R; 717/173; 726/19; 714/E11.024

(57) ABSTRACT

A method of evaluating and acquiring charged-off debt portfolios that includes providing a seller with an assessment mechanism for the debt portfolio, receiving from the seller a proposed price and debt account information for the debt portfolio based on the use of the assessment mechanism, and determining whether to acquire the debt portfolio based on the use of the assessment mechanism. The method may include a computer implemented method of assessing a portfolio of debt accounts using an assessment mechanism that includes collecting debt account information, storing the debt account information in an account record, creating a debt portfolio, and valuating the debt portfolio.

This application claims the benefit of U.S. Provisional Patent Application Ser. No. 60/950,463, filed Jul. 18, 2007, the entire disclosure of which is hereby incorporated by reference.

### FIELD OF THE INVENTION

The present invention relates generally to debt valuation systems and, more particularly, to a system and method for providing a debt valuation system to debt sellers that allows the seller to valuate a portfolio of debt accounts before transmitting information to a buyer and thereafter transmit the portfolio to the buyer for potential sale.

### BACKGROUND OF THE INVENTION

Lending institutions provide loans or lines of credit to customers with pre-arranged repayment terms. A customer has the obligation to repay the debt according to the arranged terms. Lenders cannot totally avoid the situations where customers ultimately do not comply with the repayment terms. When a customer stops paying on a credit account with a positive balance, the lender decides how to handle the outstanding debt and may attempt to recover at least some of the loss that the account balance represents. Initially, a variety of notices may be used to encourage the customer to begin paying on the account again. However, a lender may at some point classify the account as “charged-off,” e.g., after a substantial period of non-payment. A charged-off account generally represents that the lender has recognized the unlikelihood of collecting on the full debt obligation. When an account is charged-off, the lender may close the account and “write it off” (e.g., the account is considered a loss, rather than a receivable asset) in the lender's financial statements.

There are several ways in which lenders may deal with charged-off accounts. Some common approaches include the use of internal or external departments that negotiate settlement or refinancing terms with the customer for the repayment of some or all of the debt, where the terms may be different than those originally associated with the account. Another alternative is to sell the account to an outside institution that purchases the debt account at some reduced rate or charges a commission for recovered funds.

Institutions that purchase charged-off debt accounts may buy the accounts directly from the lender or through a broker. Charged-off accounts are commonly grouped together into portfolios of many accounts. A portfolio of charged-off accounts has a higher face value than individual accounts, may include various types of accounts (i.e. unsecured loans, secured loans, credit cards, negative share drafts, loan deficiency balances, lease deficiencies, lines of credit, overdraft protections), and may have accounts with varying degrees of collection potential.

### SUMMARY

According to several aspects of the invention, a system and method for valuating and transmitting debt portfolio information safely and efficiently facilitates evaluating and acquiring charged-off debt portfolios.

According to another aspect, the system and method helps lending institutions understand the debt sales process, provides them with general market pricing on charged-off accounts without a commitment to sell the accounts, and facilitates a successful sale.

According to one aspect of the invention, a method of debt evaluation for acquisition includes providing a seller with an assessment mechanism for a debt portfolio, receiving from the seller a proposed price and debt account information for the debt portfolio based on the use of the assessment mechanism, and determining whether to acquire the debt portfolio based on the use of the assessment mechanism.

According to one aspect of the invention, a computer implemented method of assessing a portfolio of debt accounts using an assessment mechanism includes collecting debt account information regarding at least one debt account, storing the debt account information in an account record, creating a debt portfolio, wherein the debt portfolio includes at least one debt account, and valuating the debt portfolio, wherein a valuation results in a proposed price for the debt portfolio.

According to another aspect of the invention, the method further includes receiving an update for the assessment mechanism, wherein the update for the assessment mechanism is provided via at least one of a download from a network or a machine readable medium.

According to another aspect of the invention, the method further includes identifying individual users of the assessment mechanism using login credentials, wherein multiple users can access the assessment mechanism using the same machine and the assessment mechanism maintains separate user profiles and data files for each user.

According to another aspect of the invention, the method further includes debt account information that is collected by at least one of importing a machine readable file containing the debt account information or obtaining information from user inputs into a machine readable form.

According to another aspect of the invention, the method further includes an assessment mechanism that provides the user a template for the machine readable file containing the debt account information.

According to another aspect of the invention, the method further includes providing warning messages when the machine readable file containing the debt account information includes questionable data, wherein the machine readable file containing the debt account information is imported and a warning log box is created to provide details of the warning messages, and providing error messages when the machine readable file containing the debt account information includes incorrect or missing data, wherein the machine readable file containing the debt account information stops importing and an error log box is created to provide details of the error messages.

According to another aspect of the invention, the method further includes providing missing information messages when the account record is missing information.

According to another aspect of the invention, the method further includes an account record that is editable after the debt account information is collected.

According to another aspect of the invention, the method further includes a valuation that is at least one of a preliminary valuation or a transmittal valuation, wherein the preliminary valuation does not require all of the debt account information required for the transmittal valuation.

According to another aspect of the invention, the method further includes transmitting the transmittal valuation for the debt portfolio, wherein the transmittal valuation includes the proposed price and the debt account information for the debt portfolio.

According to one aspect of the invention, a computer implemented method of assessing a portfolio of debt accounts using an assessment mechanism includes receiving a transmittal valuation for a debt portfolio, wherein the transmittal valuation includes the proposed price and the debt account information for the debt portfolio, storing the transmittal valuation, and managing the transmittal valuation, wherein managing includes at least one of viewing, searching, comparing, sorting, editing, calculating, extracting, or deleting.

According to another aspect of the invention, the method further includes providing an update for the assessment mechanism, wherein the update for the assessment mechanism is provided via at least one of a download from a network or a machine readable medium.

According to another aspect of the invention, the method further includes identifying individual users of the assessment mechanism using login credentials, wherein multiple users can access the assessment mechanism using the same machine and the assessment mechanism maintains separate user profiles, data files, and access for each user.

According to another aspect of the invention, the method further includes managing at least one of default file locations, profiles, users, or passwords and charting user information, wherein the user information includes at least one of user name, first name, last name, email, active/inactive, or last login.

According to one aspect of the invention, a computer system for assessing a portfolio of debt accounts using an assessment mechanism, comprising a computer including at least one of a processor and a memory, configured to collect debt account information regarding at least one debt account, store the debt account information in an account record, create a debt portfolio, wherein the debt portfolio includes at least one debt account, and valuate the debt portfolio, wherein a valuation results in a proposed price for the debt portfolio.

According to one aspect of the invention, a computer system for assessing a portfolio of debt accounts using an assessment mechanism, comprising a computer including at least one of a processor and a memory, configured to receive a transmittal valuation for a debt portfolio, wherein the transmittal valuation includes the proposed price and the debt account information for the debt portfolio, store the transmittal valuation, and manage the transmittal valuation, wherein managing includes at least one of viewing, searching, comparing, sorting, editing, calculating, extracting, or deleting.

According to one aspect of the invention, a program stored on a machine readable medium, the program for assessing a portfolio of debt accounts using an assessment mechanism and comprising executable logic to collect debt account information regarding at least one debt account, store the debt account information in an account record, create a debt portfolio, wherein the debt portfolio includes at least one debt account, and valuate the debt portfolio, wherein a valuation results in a proposed price for the debt portfolio.

According to one aspect of the invention, a program stored on a machine readable medium, the program for assessing a portfolio of debt accounts using an assessment mechanism and comprising executable logic to receive a transmittal valuation for a debt portfolio, wherein the transmittal valuation includes the proposed price and the debt account information for the debt portfolio, store the transmittal valuation, and manage the transmittal valuation, wherein managing includes at least one of viewing, searching, comparing, sorting, editing, calculating, extracting, or deleting.

These and further embodiments will be apparent with reference to the following description and attached drawings. In the description and drawings, particular embodiments have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic block diagram of an exemplary computer system that may be used to implement a system of debt evaluation for acquisition in accordance with the present invention;

FIG. 2 is a flow chart representing a debt valuation and purchase process in accordance with the present invention;

FIG. 3 is a schematic block diagram of an exemplary debt portfolio assessment mechanism;

FIG. 4 is a flow chart representing the user interface with the debt portfolio assessment mechanism in accordance with the present invention;

FIG. 5 is a flow chart representing the administrator interface with the debt portfolio assessment mechanism in accordance with the present invention; and

FIG. 6 is an exemplary debt portfolio valuation generated using the debt portfolio assessment mechanism in accordance with the present invention.

### DETAILED DESCRIPTION OF EMBODIMENTS

Exemplary embodiments of the invention will now be described with reference to the drawings, wherein like reference numerals are used to refer to like elements throughout. It will be understood that the figures are not necessarily to scale.

### A. INTRODUCTION

The methods and systems described herein relate to debt evaluation for the purpose of acquisition. These methods and systems have particular application to providing a debt assessment mechanism to debt sellers that allows a seller to valuate a portfolio of charged-off debt accounts before transmitting information to a buyer, and if the seller wants to sell the portfolio at the valuation price, a method and system to transmit the portfolio of charged-off debt accounts to the buyer for possible purchase.

For purposes of the description herein, an exemplary seller will be an institution interested in selling charged-off debt accounts. The seller may be any lending institution, such as a bank, credit union, credit card issuer, or other financial institution, or a debt account broker. Accordingly, for purposes of the description herein, the methods and systems of the invention will be described by way of example in relation to a credit union as the seller.

For purposes of the description herein, by way of example, an exemplary buyer will be an institution that has experience in valuating and purchasing debt portfolios. The buyer may be an agency that may pursue debt resolutions directly or indirectly with customers or a broker that may resell the accounts.

For the seller, the process of selling a debt portfolio to the buyer may include various phases, including gathering charged-off account information, grouping accounts into a portfolio, soliciting quotes, and final negotiations and sale. The charged-off account information required to sell a debt portfolio may be detailed and must meet the requirements of the buyer. The information required for each charged-off account may include the details about the customer, co-debtor if applicable, account terms, payments, security, charge-off, and lender. The seller may group various charged-off accounts into a portfolio at the seller's discretion. During this process, a less sophisticated seller may not have an accurate estimate of the market value of the portfolio until the seller receives quotes from potential buyers. Sellers may form relationships with particular buyers and may prefer to negotiate with previous buyers of their portfolios.

For the buyer, the process may include contacting potential sellers, verifying seller credentials, communicating account information requirements, confirming account information, valuating the portfolio, making an offer, and final negotiations and purchase. The charged-off account information initially submitted from the seller may not be accurate or may not include all of the information that the buyer needs to valuate the portfolio. Several communications may be required between the buyer and the seller before the buyer has all of the information necessary to make an offer. In some situations, the buyer may remove certain accounts from the portfolio, for example, if an account's customer is deceased or has claimed bankruptcy.

These processes may be streamlined and implemented using the methods and systems of the invention contained herein. The debt evaluation method and system includes a debt portfolio assessment mechanism. The assessment mechanism may simplify various portions of the debt portfolio acquisition process, such that the seller and buyer may be able to complete the transaction safely and efficiently. For instance, the assessment mechanism allows the seller to input a minimum amount of information regarding their charged-off debt accounts to receive a valuation of those accounts without contacting any buyers. This allows the seller to assess quickly the general market value of the portfolio without the time and expense of formally soliciting quotes from potential buyers. The seller also may add and delete certain charged-off accounts to and from the portfolio to assess easily the impact each account has on the portfolio's value.

In addition, in an embodiment the assessment mechanism requires the seller to complete forms that contain fields for information that the buyer has identified as necessary for a purchase of the debt portfolio. These forms cover information related to the seller and each charged-off account included in the portfolio. If these forms are incomplete, the seller receives an error message identifying the missing information and the seller cannot transmit the portfolio to the buyer until the information is provided. This minimizes the amount of back-and-forth communication between the buyer and the seller necessary to exchange all of the information required for a sale. Using another function of the assessment mechanism, after seeing the valuation, the seller may transmit the debt portfolio information directly to the buyer for validation and purchase.

The method and system are advantageous because the seller can install the assessment mechanism on their own system, receive prompt feedback regarding the completeness of the charged-off account information provided, obtain a prompt valuation for the debt portfolio, and transmit the debt portfolio information to the buyer to start the purchase process. Similarly, the buyer can install the assessment mechanism on their own system, receive debt portfolios directly from sellers with complete information, and pursue the purchase of the debt portfolio knowing that the seller is interested in selling at the valuated price.

### B. SYSTEM CONFIGURATION

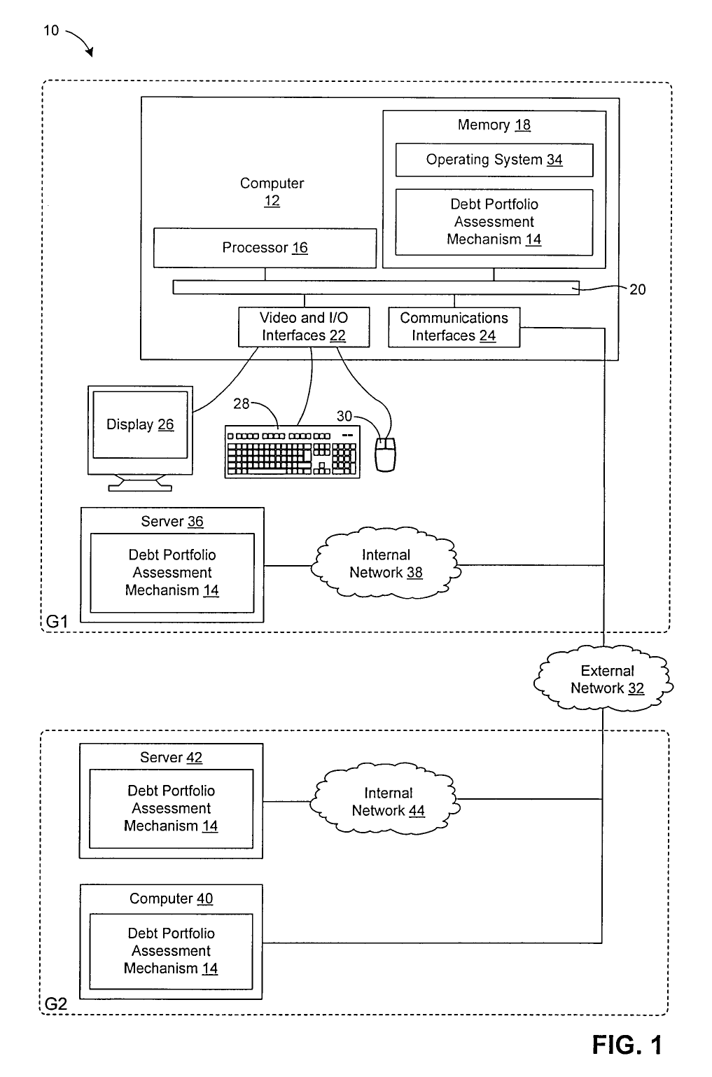

With reference to FIG. 1, illustrated is a schematic block diagram of a computer-based system 10 capable of executing computer applications (e.g., software programs). The computer system 10 may include a computer 12 that may be used to carryout the assessment and possibly to assist in carrying out a sale of a debt portfolio of a financial institution, for example, of a credit union, hereafter referred to as the seller. A representative of the seller interfacing with the computer 12 will hereafter be referred to as the user. The computer 12 may be configured to execute executable portions of a debt portfolio assessment mechanism 14 and/or to store database portions of the debt portfolio assessment mechanism 14. As will be described below, the assessment mechanism 14 may be executed and/or stored in whole or in part by other components of the system 10. For illustrative purposes, the seller's group of system 10 devices is designated by the dashed box G1.

In one embodiment, the debt portfolio assessment mechanism 14 is embodied as one or more computer programs (e.g., one or more software applications including compilations of executable code) and/or one or more database structures. The computer program(s) and/or databases may be embodied on a machine (e.g., computer) readable medium, such as a magnetic, optical or electronic storage device (e.g., hard disk, optical disk, flash memory, etc.).

To execute the assessment mechanism 14, the computer 12 may include one or more processors 16 used to execute instructions that carry out a specified logic routine(s). In addition, the computer 12 may have a memory 18 for storing data, logic routine instructions, computer programs, files, operating system instructions, and the like. As illustrated, the assessment mechanism 14 may be stored by the memory 18. The memory 18 may comprise several devices, including volatile and non-volatile memory components. Accordingly, the memory 18 may include, for example, random access memory (RAM), read-only memory (ROM), hard disks, floppy disks, optical disks (e.g., CDs and DVDs), tapes, flash devices and/or other memory components, plus associated drives, players and/or readers for the memory devices. The processor 16 and the memory 18 are coupled using a local interface 20. The local interface 20 may be, for example, a data bus with accompanying control bus, a network, or other subsystem.

The computer 12 may have various video and input/output (I/O) interfaces 22 as well as one or more communications interfaces 24. The video and I/O interfaces 22 may be used to operatively couple the computer 12 to various peripherals, such as a display 26, a keyboard 28, a mouse 30, a microphone (not shown), a camera (not shown), a scanner (not shown), a printer (not shown), a speaker (not shown) and so forth. The communications interfaces 24 may include for example, a modem and/or a network interface card. The communications interfaces 24 may enable the computer 12 to send and receive data signals, voice signals, video signals, and the like to and from other computing devices via an external network 32 (e.g., the Internet), a wide area network (WAN), a local area network (LAN), direct data link, or similar systems. The interface between the computer 12 and any operatively interfaced device or network may be wired or wireless.

The memory 18 may store an operating system 34 that is executed by the processor 16 to control the allocation and usage of resources in the computer 12, as well as provide basic user interface features. Specifically, the operating system 34 controls the allocation and usage of the memory 18, the processing time of the processor 16 dedicated to various applications being executed by the processor 16, and the peripheral devices, as well as performing other functionality. In this manner, the operating system 34 serves as the foundation on which applications, such as the assessment mechanism 14, depend as is generally known by those with ordinary skill in the art. The operating system 34 also controls much of the user interface environment presented to a user, such as features of the overall graphical user interface (GUI) for the computer 12.

The computer system 10 may include computing devices in addition to the computer 12. For example, the computer system 10 may include a server 36 that stores and/or executes the assessment mechanism 14. As will be appreciated, the server 36 may be configured as a typical computer used to carry out server functions. For instance, the architecture of the server 36 may be similar to the architecture of the computer 12, such as including a processor configured to execute software containing logical instructions that embody the functions of the server 36 and a memory to store such software and related data.

In the illustrated embodiment, the server 36 and the computer 12 are networked for the exchange of data and information over an internal network 38. For example, the internal network 38 may be a private network of the seller.

The computer system 10 also may include computing devices for the buyer. For illustrative purposes, the buyer's group of system 10 devices is designated by the dashed box G2. For example, a computer 40, configured as a typical computer system used to carry out computing functions, similar to computer 12, may also store and/or execute the assessment mechanism 14. For instance, the architecture of the computer 40 may be similar to the architecture of the computer 12, such as including a processor configured to execute software containing logical instructions that embody the functions of the computer 12 and a memory to store such software and related data. The computer 40 may be used to carryout the assessment and possibly the purchase of the debt portfolio for the buyer. A representative of the buyer interfacing with the computer 40 will hereafter be referred to as the administrator. The system 10 may include a server 42 that stores and/or executes the assessment mechanism 14, and may be configured for the buyer in a similar fashion as the server 36. The server 42 and the computer 40 are networked for the exchange of data and information over an internal network 44. For example, the internal network 44 may be a private network of the buyer.

The computer 12 also may exchange data with the server 42 and/or the computer 40 via the external network 32. For example, the computer 12 may transmit data to the server 42 and/or the computer 40 over the Internet, serving as the external network 32. In this configuration, the system 10 allows the seller, user of the computer 12, to transmit debt portfolio information to the buyer, administrator of the computer 40, using the assessment mechanism 14. This arrangement may be convenient because the buyer's location may be remote from the seller's location.

In other embodiments or at other times during the debt portfolio acquisition process, the computer 12 may interface directly with the internal network 44 and/or the server 42. Similarly, the computer 40, the server 42, the computer 12, and/or the server 36, may communicate and exchange data with each other and/or any other device of the system 10. The system 10 may include more than one seller and/or buyer, which may be coupled through the external network 32. Also, the computer 12, the server 36, the computer 40, and/or the server 42 may operate as stand-alone devices while executing portions of the assessment mechanism 14.

In one embodiment, the entire assessment mechanism 14 is resident in and/or executed by the computer 12. In other embodiments, some or all of the assessment mechanism 14 is resident in and/or executed by the server 36. Similarly, in other embodiments, some or all of the assessment mechanism 14 is resident in and/or executed by the computer 40 and/or server 42. Thus, all or a portion of the assessment mechanism 14 may be distributed throughout portions of the computer system 10. In a specific example, the assessment mechanism 14 may be resident and executed by the computer 12 of the seller and the assessment mechanism 14 may be resident and executed by the computer 40 of the buyer.

In another alternative, master copies of various database components of the assessment mechanism 14 may be hosted by the server 36 and/or the server 42 and copies of the databases may be stored by the computer 12 and/or the computer 40 so that the computers may operate independently from the remainder of the computer system 10. Furthermore, functional components of the assessment mechanism 14 may be carried out by the server 36 and/or the server 42. For instance, the server 42 may be configured to host an Internet-style website accessible by the computer 12. Through the website, the user of the computer 12 may enter information, such as a seller's user profile, and the server 42 may execute a system component of the assessment mechanism 14 to receive the information from the computer 12 for additional processing and/or display.

The assessment mechanism 14 also may include security provisions to ensure that user, customer, and account information is maintained and transmitted confidentially, e.g., all transmissions may be 128 bit encrypted Secure Sockets Layer (SSL) and data files may incorporate a proprietary file format utilizing Data Encryption Standard (DES).

The block diagram and flowcharts represented in FIGS. 3-5 illustrate the functionality of the methods and systems of the present invention, and may not portray the organization of specific programming code and database structures. It will be apparent to a person having ordinary skill in the art of computer programming, and specifically in application programming for data collection, data processing and/or expert systems, how to program a computer system 10 to operate and execute logical functions associated with the assessment mechanism 14. Accordingly, details as to specific programming code and database structures have been left out for the sake of brevity. Also, while the assessment mechanism 14 is executed by respective computers in accordance with a preferred embodiment of the invention, such functionality could also be carried out via dedicated hardware, firmware, software, or combinations thereof, without departing from the scope of the invention.

### C. ASSESSMENT MECHANISM AS PART OF DEBT VALUATION AND PURCHASE METHOD

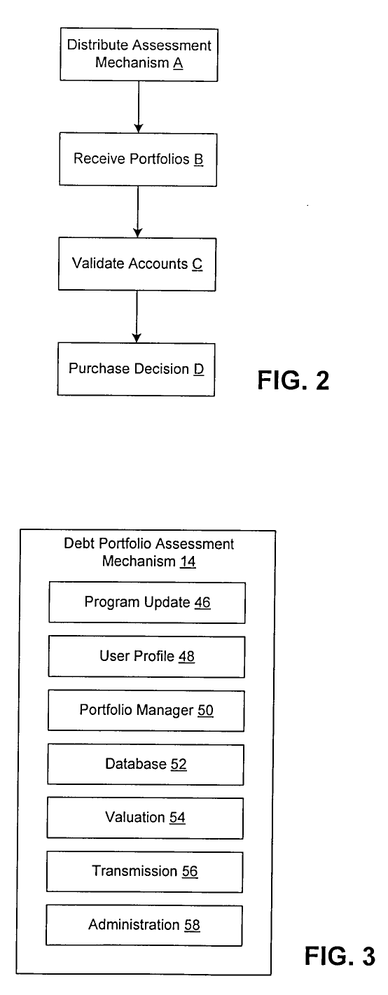

Referring now to FIG. 2, the assessment mechanism 14 described herein may be part of a business method of debt valuation for purchase. The logical flow of the debt valuation for purchase process may begin in block A where a debt portfolio buyer may distribute a debt portfolio assessment mechanism 14 to one or more debt portfolio sellers. Distribution to sellers can be accomplished by providing sellers a version of the assessment mechanism 14 on a machine readable medium, by providing sellers access to a downloadable version of the assessment mechanism 14 from a server 42, or any other delivery method.

After assessment mechanism 14 distribution in block A, the logical flow may proceed to block B where the buyer may receive debt portfolios transmitted from sellers. By using the assessment mechanism 14, the seller may transmit the portfolio from the computer 12 to the computer 40 or to the server 42. The buyer can use administrative functions of the assessment mechanism 14 to receive portfolios from sellers.

After receiving portfolios in block B, the logical flow may proceed to block C where the buyer may validate the account information in the portfolios. During the validation block C, the buyer may revise the portfolio and communicate with the seller regarding details of the portfolio transmitted from the seller and conditions of sale, i.e., the buyer may notify the seller that an account should be removed from the portfolio before the buyer would be willing to purchase the portfolio. The buyer may request that the seller re-transmit a portfolio to the buyer after accounts have been removed for documentation verification and archival purposes.

After validating the portfolio in block C, the logical flow may proceed to block to D where the buyer may decide to purchase the portfolio from the seller. The purchase process may include several post-transmission activities. The buyer may submit an offer price, statement of accounts, and a contract to the seller for final acceptance. The buyer may transfer funds to the seller when the buyer has received an executed contract from the seller. After receiving the funds, the seller may execute a bill of sale and send it to the buyer via facsimile, email, or other agreed upon means. The seller may then notify the customers of the accounts in the portfolio that the account was sold and inform member service personnel. The seller may send duplicate, executed hardcopies of the contract to the buyer for buyer signatures. After signing, the buyer may then return one set of the original executed contracts to the seller. The seller may forward all necessary account documentation to the buyer and provide any necessary post sale support.

### D. COMPONENTS

With additional reference to FIG. 3, illustrated is a functional block diagram of exemplary components of the debt portfolio assessment mechanism 14. The assessment mechanism 14 may include various modules of code relating to certain functions of the assessment mechanism 14. Exemplary modules include a program update module 46, a user profile module 48, a portfolio manager module 50, a database module 52, a valuation module 54, a transmission module 56, and an administration module 58. The functions of these modules and other functions of the assessment mechanism 14 will be described in detail below. The various modules of the assessment mechanism 14 may interact with each other, other software programs, and/or various databases. The data stored by the assessment mechanism 14 in the database 52 will be described in detail below.

As indicated, some or all of the components for the debt portfolio assessment mechanism 14 may be omitted from the assessment mechanism 14 as executed and/or stored by the computer 12 and/or the computer 40 in favor of executing and/or storing the omitted components with the server 36 and/or the server 42. However, for purposes of providing a concise description, the assessment mechanism 14 will be described in an arrangement that is executed and stored by the computer 12 and the computer 40, unless otherwise indicated.

### E. LOGICAL FLOW

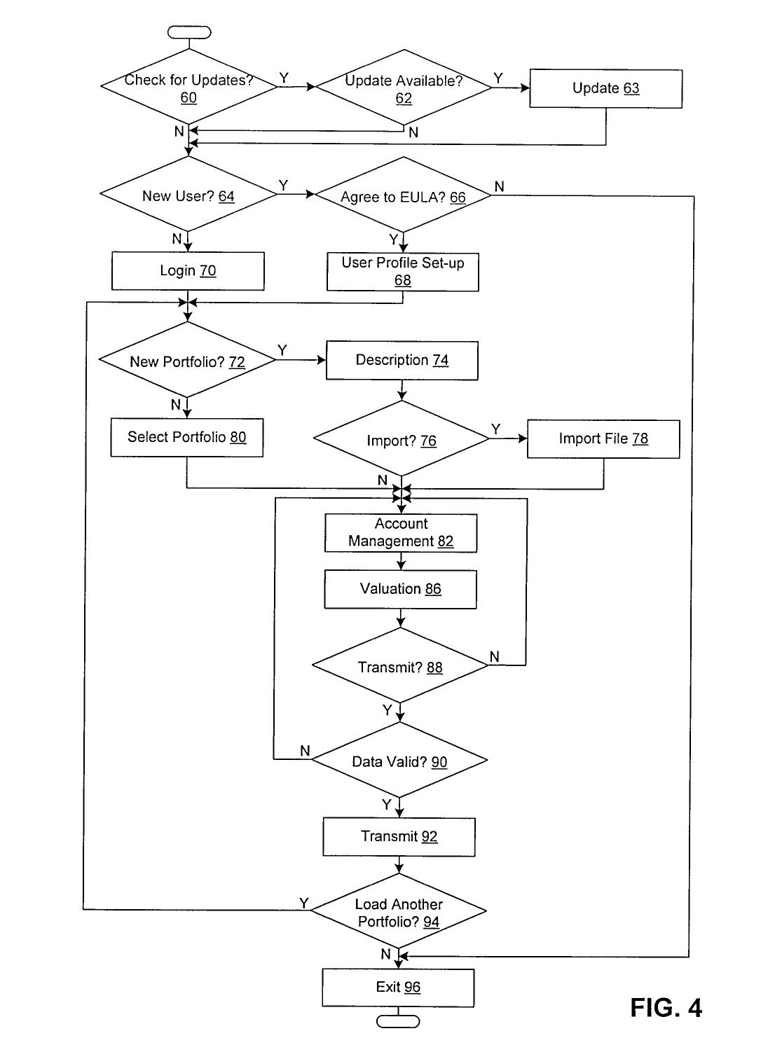

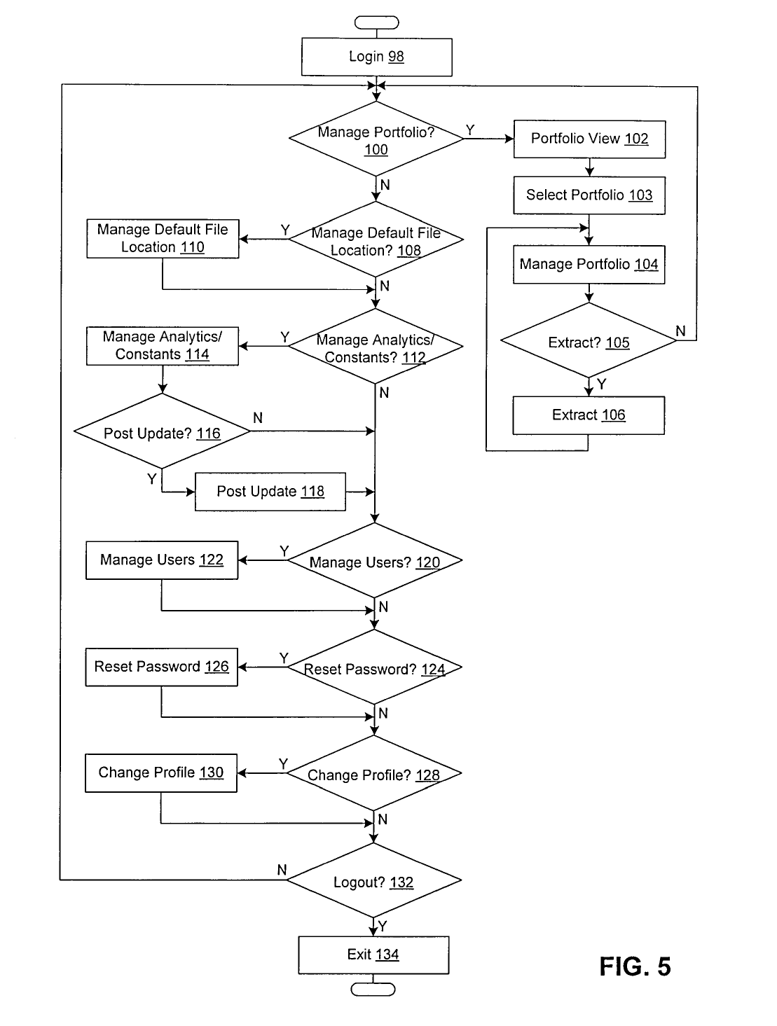

With additional reference to FIGS. 4 and 5, illustrated are logical operations to implement an exemplary method of debt evaluation for the purposes of acquisition. FIG. 4 illustrates the logical operations of a user (i.e. representing the seller) interface of the assessment mechanism 14; FIG. 5 illustrates the logical operations of an administrator (i.e. representing the buyer) interface of the assessment mechanism 14. The exemplary method may be carried out by executing an embodiment of the debt portfolio assessment mechanism 14, for example. Thus, the flow charts of FIGS. 4 and 5 may be thought of as depicting steps of a method carried out by the computer system 10.

Although FIGS. 4 and 5 show a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores, or messages may be added to the logical flow for purposes of enhanced utility, accounting, performance, measurement, troubleshooting, and the like. It is understood that all such variations are within the scope of the present invention.

The database 52 module of the assessment mechanism 14 is referenced throughout the logical flow in relation to the other modules. The database 52 stores data required by the other modules. Several modules of the assessment mechanism may utilize the database 52 at the same time. It will be apparent to a person having ordinary skill in the art of computer programming, and specifically in application programming for data collection, storage, and/or processing how a program interfaces with a database to store data.

### E(1). Program Update (Shown as Module 46 in FIG. 3)

Referring now to FIG. 4, the logical flow for the debt portfolio assessment mechanism 14 for the seller may begin in block 60 where a determination is made as to whether the user would like to check for updates to the assessment mechanism 14. If a check for updates is desired, a positive determination may be made in block 60. If a check for updates is not desired, a negative determination may be made in block 60. A new user that has not used the program should always allow the assessment mechanism 14 to search for and obtain any available updates. Updating can be a quick process and ensures the seller of up-to-date valuation and program enhancements. The updates may include new or revised programming code, program features, reference documents, analytics, constants, or any other portion of the assessment mechanism 14. For instance, the buyer may decide to revise their analytics for determining portfolio valuations. An existing user should check for updates at least once a month. Any user that attempts to transmit a debt portfolio to the buyer without installing the most recent update will be prompted to restart the assessment mechanism 14 and download the latest update before transmission.

Upon a positive determination in block 60, the logical flow may proceed to block 62 where a determination is made as to whether an update is available for the version of the assessment mechanism 14 in the computer 12. Upon a positive determination in block 62, the logical flow may proceed to block 63 where the update may be downloaded to the computer 12. For example, in block 62, the computer 12 may communicate with the server 42 to determine if an update is available for the version of the assessment mechanism 14 in the computer 12. The server 42 can determine which version of the assessment mechanism 14 is in the computer 12 and in block 63 downloads an update to the computer 12 if a newer version is available. If an update is downloaded, the computer 12 can receive the update from the server 42 and the assessment mechanism 14 in the computer 12 updates accordingly. Depending on the nature of the update, the computer 12 may need to restart the assessment mechanism 14 or restart the computer 12 before the update process is completed. If the assessment mechanism 14 in the computer 12 is the latest version of the assessment mechanism 14, then no update is required and the server 42 will not download a new version to the computer 12.

In another embodiment, the updates may be distributed from the buyer to the seller via a machine readable medium.

### E(2). User Profile (Shown as Module 48 in FIG. 3)

Still referring to FIG. 4, upon completion of the update process in block 63, if a negative determination is made in block 62, or if a negative determination is made in block 60, the logical flow may proceed to block 64 where a determination is made as to whether the user is a new user of the assessment mechanism 14. If the user is a new user, a positive determination may be made in block 64. If the user is an existing user, a negative determination may be made in block 64. The assessment mechanism 14 allows multiple users to access the same assessment mechanism 14 on the computer 12, but each user should use a separate user name and password.

Upon a positive determination in block 64, the logical flow may proceed to block 66 in which an end-user license agreement (EULA) is displayed to the new user. The new user must agree to the EULA to proceed with the assessment mechanism 14. If the new user does not agree with the EULA, the assessment mechanism 14 terminates. Upon agreeing to the EULA, the logical flow may proceed to block 68 in which the user is prompted to enter information regarding the credit union, for example, credit union name, charter number, and location.

The assessment mechanism 14 may include a database of credit unions. In block 68, the new user can type the credit union's name into the credit union name field. The field may begin auto-populating after the first few keystrokes and will become more accurate as more characters are entered. Once the correct name is recognized, a charter number and address should display. If the credit union name is not recognized, the new user may manually enter the name of the credit union to proceed. The user may also select from a list of credit unions in the database, scroll through the list to find the correct credit union, and select the matching credit union from the list. If the user is able to select the credit union from the list provided by the assessment mechanism 14, the charter number and address should display. If the user's credit union is not included in the database list or the accompanying information is not correct, the user may type the correct information into the appropriate fields. The new user also is prompted to complete a user profile that includes several fields, for example, user name, address, password, phone number, fax number, and email address. The assessment mechanism 14 stores user information in the database 52 separately for each user. Stored user information can be edited later. Once the new user profile has been stored by the assessment mechanism 14, the user can thereafter login as an existing user.

Upon a negative determination in block 64, the logical flow may proceed to block 70 in which the existing user selects the appropriate user name from a list and then is requested to enter the existing user's password, which was initialized during a previous login as part of the new user set-up process in block 68. If an existing user wishes to change his password, there is a user information page available to the existing user after logging in. Lost or forgotten user passwords may be reset by contacting the assessment mechanism 14 administrator.

### E(3). Portfolio Manager (Shown as Module 50 in FIG. 3)

Upon completion of the new user profile set-up in block 68 or completion of the existing user login in block 70, the logical flow may proceed to block 72 where a determination is made as to whether the user wants to add, delete, or edit a portfolio. A portfolio is a collection of at least one charged-off account that the seller is interested in valuating and/or selling. The assessment mechanism 14 stores portfolios and account records in the database 52 separately for each user. The portfolio center in block 72 will display any stored portfolios previously created by the user. Only the portfolios inputted or imported by the current user will be displayed. For the user's reference, every stored portfolio is displayed with a load date and the latest date of any modifications. When a portfolio is initially loaded into the assessment mechanism 14, the load date and update date will be the same. If a portfolio has been transmitted to the buyer for purchase or analysis, the assessment mechanism 14 may also display a transmission identification (ID) number and date of transmission.

If the user wants to add a new portfolio, a positive determination may be made in block 72. If the user wants to edit a stored portfolio, a negative determination may be made in block 72. To add a new portfolio, the user may click on the “New Portfolio” option, which will take the user to the new portfolio page. “Click” refers generally to an action by a computer user, in response to an option provided by the assessment mechanism 14, which indicates to the assessment mechanism 14 a selection or choice by the user, i.e., using the mouse 30 to point to an option on the display 26 and pressing a mouse 30 button one or two times to select that option. Editing a portfolio will be discussed in detail below. To delete a portfolio, the user clicks on the desired portfolio, and after a confirmation, the portfolio is deleted.

Upon a positive determination in block 72, the logical flow may proceed to the new portfolio page in block 74 in which the user is prompted to provide a description of the new portfolio. After entering the description of the new portfolio, the logical flow may proceed to block 76 where a determination is made as to whether the new portfolio will be imported from a spreadsheet. The assessment mechanism 14 allows the user to create portfolios in two ways: importing account information from a spreadsheet; and/or manually entering account information. If the user wants to import the portfolio from a spreadsheet, a positive determination may be made in block 76. If the user does not want to import a portfolio, a negative determination may be made in block 76. With larger portfolios, it may be easier to load a spreadsheet using the import process. When the user has a small number of accounts and wants to determine a valuation quickly, the user may enter the minimum amount of account information, which only allows for a preliminary valuation.

Upon a positive determination in block 76, the logical flow may proceed to the import file block 78. The import file function may be used when the user wants to load a new portfolio from a properly formatted spreadsheet or other data collection and presentation structure, e.g., an Excel spreadsheet. If the user imports account information from the spreadsheet, the assessment mechanism 14 requires that the account information in the spreadsheet include detailed and complete information, which is also necessary to generate a transmittal valuation. The assessment mechanism 14 may also include a sample Excel template for the spreadsheet, which describes the field names, format, and layout required for a successful import process. An improperly prepared spreadsheet may generate errors or warnings. The required account information, errors, and warnings are discussed in detail below. In block 78, to load an Excel spreadsheet, the user clicks on the “Open File” option and a directory window will appear. The user may browse to the correct directory or folder and click on the spreadsheet file to import. If the spreadsheet file does not contain errors or warnings, a window will appear with “Import Complete.”

Detailed and complete account information is necessary for a successful spreadsheet file import. The assessment mechanism 14 stores the account information from the spreadsheet as account records in the database 52 separately for each user. The account information required may include the customer's full name, account number, address, phone number, social security number (SSN), date account was opened, date of last payment, last payment amount, date of charge-off, principle amount, interest, interest rate, interest through date, original lender, credit type, type of security, and similar co-debtor information if applicable. Each of the required fields is organized in a separate column and has a particular name that must be included in the imported spreadsheet. The spreadsheet template provided by the assessment mechanism 14 describes the exact format of these fields and their contents.

The assessment mechanism 14 may display warning and/or error messages if there is incomplete or missing information in the spreadsheet. If a spreadsheet is imported and a “Warnings Found” dialog box appears, it means that there are accounts that may have questionable data that should be reviewed. However, the portfolio import can continue with warnings and the user can review and/or repair accounts in the account details page after the import is completed. The assessment mechanism 14 may display a printable warning log box showing the exact cells where the questionable data resides and why the warning was generated. The warning log box is also stored in the database 52 and be can be viewed later. Warnings may be generated, for example, when characters or numbers that exceed the established field size limits have been truncated, a postal ZIP code is missing, or an interest rate equals zero.

If a spreadsheet is imported and an “Errors Found” dialog box appears, it means that there are accounts that may have incorrect or missing data that must be corrected to proceed. Unlike warnings, a portfolio import with errors will terminate. To import a portfolio with errors, repairs need to be made in the source spreadsheet before the file can be re-imported. The assessment mechanism 14 may display a printable error log box showing the exact cells where the incorrect data resides or is missing and why the error was generated. The error log box is also stored in the database 52 and can be viewed later. Errors may be generated, for example, when a name is missing, a date format is invalid, or an account charge-off date is earlier than an account open date.

Upon a negative determination in block 76 to import a portfolio from a spreadsheet file, the other method of creating a new portfolio is manually entering account information. Manually entering account information may be used if an Excel spreadsheet is unavailable or if the user would prefer to input the account information directly into the assessment mechanism 14. The user can receive the preliminary valuation of the portfolio after the minimum information is entered for the charged-off accounts. The preliminary valuation method may also be referred to as a “Quick Quote.” The Quick Quote feature may be useful when the user has a relatively small number of accounts and only wants to enter in a few data fields in order to get the preliminary valuation quickly. Determining whether to utilize the import process or the Quick Quote feature of the assessment mechanism 14 to enter accounts is at the user's discretion. If the user does not import a portfolio, the Quick Quote is the only other option available to the user in block 76. Clicking on the Quick Quote option will take the user to the account details page, described in detail below. The assessment mechanism 14 cannot transmit a portfolio to the buyer when the Quick Quote function was used to create the portfolio until additional account details are entered.

Upon a negative determination in block 72, the logical flow may proceed to the select portfolio block 80 in which the user selects a stored portfolio to edit. Editing a portfolio may be desirable when the user wishes to add or delete accounts to determine the resulting changes to the portfolio valuation. Every time an account is edited, deleted, or added, the assessment mechanism 14 changes the previously stored version of that portfolio in the database 52, regardless of whether the portfolio was initially entered manually or imported from a spreadsheet. For data consistency purposes, if the user wishes to edit an imported portfolio before transmission to the buyer, the user should edit the original source spreadsheet, re-import, and store the imported file as a new portfolio before transmission to the buyer. In block 80 of the assessment mechanism 14, selecting a portfolio to edit may be accomplished in two different ways: clicking on the desired portfolio; or selecting and highlighting the portfolio and then clicking on the “Edit Portfolio” option.

Upon selecting a portfolio to edit in block 80, a negative determination to import a file in block 76, or the completion of the import file block 78, the logical flow may proceed to the account management block 82 in which the user can view, input, and edit the accounts in the portfolio. The account management page of the assessment mechanism 14 consists of two main areas: the account list; and account information. The account list will contain the complete list of accounts in the portfolio. The account information area is where the user will view, input, or edit individual accounts.

The assessment mechanism 14 displays the account list to allow the user to find specific accounts easily. To edit an account, the user clicks on the account that the user wants to edit, which will then cause the assessment mechanism 14 to retrieve the account information from the database 52 and display the account information. The assessment mechanism 14 will display the accounts in the same order that they were inputted or imported, but they may be sorted by last name if desired by the user. To delete an account, the user selects and highlights the account and then clicks on a “Delete Account” option. To add an account, the user clicks on an “Add New Account” option, which provides blank fields in the account information section in which the user can input the appropriate account information.

In the account information section, the assessment mechanism 14 flags any field that is required information with an asterisk (*). If an account has missing information and the user attempts to move to another account, the assessment mechanism 14 will display a flashing red circle with an exclamation point (!) next to the field. When all accounts are entered or repaired, the user may click on the “Finish” option. If all of the accounts are properly entered, a “Calculate Valuation” option will turn green. In this manner, the assessment mechanism 14 displays to the user what information is required before the user can initiate a valuation.

### E(4). Valuation (Shown as Module 54 in FIG. 3)

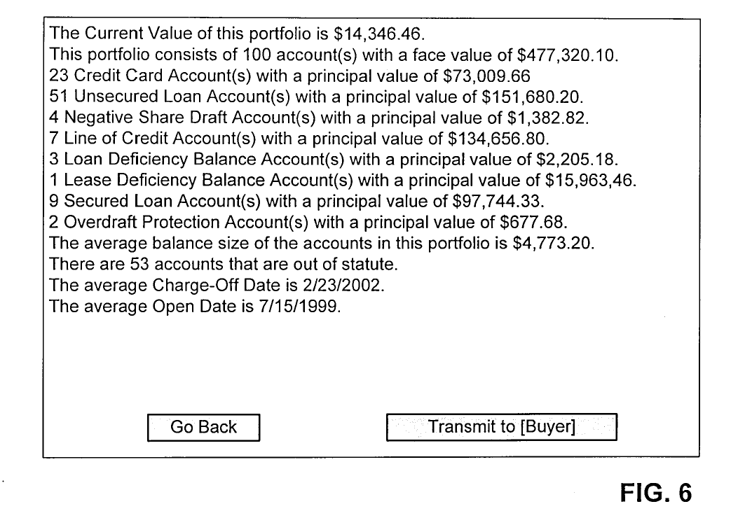

Proceeding to block 86, the user may click on the “Calculate Valuation” option. The assessment mechanism 14 will then calculate a valuation and display a portfolio valuation page that will provide an initial valuation of the portfolio and statistical breakdown. FIG. 6 shows an exemplary debt portfolio valuation generated using the assessment mechanism 14. The portfolio valuation page will provide a market value that the buyer will typically pay for the portfolio as well as a breakdown of account types and averages. The portfolio valuation page includes a “Transmit to [Buyer]” option.

At this point in the logical flow, the assessment mechanism 14 has not transmitted any portfolio information to the buyer. The seller may assess the general market value of the debt portfolio using the assessment mechanism 14 before committing to sell the debt portfolio to the buyer. In this manner, the seller is able to create portfolios, modify portfolios, and receive portfolio valuations quickly and securely because the assessment mechanism provides the valuation to the seller as soon as the seller can enter the portfolio account information into the assessment mechanism 14. The seller avoids the time and expense of compiling information and soliciting quotes to receive a valuation of a portfolio. In addition, the assessment mechanism 14 lets the seller modify the accounts in the portfolio easily, understand the impact of the modifications to the portfolio valuation, and configure their portfolio accordingly before transmitting to the buyer.

### E(5). Transmission (Shown as Module 56 in FIG. 3)

After portfolio valuation in block 86, the logical flow may proceed to block 88 where a determination is made as to whether the user wants to transmit the portfolio to the buyer. If the user wants to transmit the portfolio to the buyer and clicks on the “Transmit to [Buyer]” option, the assessment mechanism 14 will attempt to forward a secure encrypted file to the buyer for further analysis and/or purchase offer. Upon a positive determination in block 88, the logical flow may proceed to the data validation block 90 in which the assessment mechanism 14 validates all of the data in the portfolio before transmission.

Upon a negative determination in block 88 (user does not want to transmit) or a negative determination in block 90 (portfolio validation fails), the logical flow may proceed to the account management block 82 for further user options.

Upon a positive determination in block 90, the logical flow may proceed to the transmit block 92 in which the assessment mechanism 14 transmits the portfolio to the buyer. The assessment mechanism 14 will display a confirmation window with a transmission ID when the portfolio transmission is complete. During an exemplary transmission, the assessment mechanism 14 securely transmits the portfolio from the seller's computer 12 to the buyer's computer 40 or server 42 using the communications interfaces 24 and the external network 32. In this manner, the seller is able to transmit the portfolio to the buyer after viewing the valuation of the portfolio. If the seller does not want to offer to sell the portfolio at the valuation price, the seller can choose not to transmit the portfolio. In addition, by utilizing the assessment mechanism 14, the seller is assured that he has provided the buyer all of the required information for the transaction that the buyer has identified as required in the forms of the assessment mechanism 14.

After a successful transmission in block 92, the logical flow may proceed to block 94 where a determination is made as to whether the user wants to load another portfolio. If the user wants to load another portfolio, a positive determination is made in block 94 and the logical flow proceeds to block 72. If the user does not want to load another portfolio, a negative determination is made in block 94 and the logical flow proceeds to block 96 where the assessment mechanism 14 terminates.

### E(6). Administration (Shown as Module 58 in FIG. 3)

The assessment mechanism 14 installed on the computer 40 is used for administration by the buyer. A portfolio transmitted by the seller may be stored in the database 52 of the computer 40 or server 42 for access by the buyer. The assessment mechanism 14 may receive portfolios transmitted from more than one seller.

Referring now to FIG. 5, the logical flow of the debt portfolio assessment mechanism 14 for the buyer may begin in block 98 where an administrator will login. The logical flow in FIG. 5 includes a depiction using a series of decision blocks, but the assessment mechanism 14 may display the administration options in a menu system with clickable options used to select each function, or any other GUI. Depending on the login information, only relevant menu options will be available to the administrator. The assessment mechanism 14 maintains separate profiles and data files for all users and administrators. Therefore, some of the assessment mechanism 14 administration functions discussed below may not be available to all administrators.

The logical flow for the assessment mechanism 14 then proceeds to block 100 where a determination is made as to whether the administrator wants to manage portfolios. Upon a positive determination in block 100, the logical flow may proceed to the portfolio view block 102 in which the assessment mechanism 14 displays the portfolios available to the administrator. In block 102, the assessment mechanism 14 can indicate to the administrator how many new portfolios have been transmitted to the buyer since the administrator's last login. The assessment mechanism 14 also can search the database 52 for portfolios that meet criteria entered by the administrator. For example, the assessment mechanism 14 may allow the administrator to search for portfolios by credit union name, credit union charter number, user's last name, or transmission ID. The assessment mechanism 14 will display the results of the portfolio search initiated by the administrator.

After viewing and/or searching the portfolios in block 102, the logical flow may proceed to block 103 where the administrator can select a portfolio to manage. Any portfolio displayed by the assessment mechanism 14 is selectable, whether all of the available portfolios are displayed or only those displayed after an administrator search. The administrator may select a portfolio by clicking on the portfolio. When the administrator selects the portfolio, the assessment mechanism 14 retrieves the portfolio information from the database 52 and displays the information.

After selecting a portfolio in block 103, the logical flow may proceed to block 104 where the administrator can manage the selected portfolio. In block 104, the assessment mechanism 14 may allow the administrator to manipulate the portfolio without modifying the transmitted version of the portfolio in the database 52. For example, the administrator may be able to edit and/or delete accounts, perform calculations, make comparisons, reset the portfolio, or export the portfolio to an Excel file.

After managing the portfolio in block 104, the logical flow may proceed to block 105 where a determination is made as to whether the administrator wants to extract the portfolio. The assessment mechanism 14 can extract the portfolio into other folders for use by other programs. Since the buyer may use several other programs as part of their purchasing decision, the assessment mechanism 14 may offer the administrator several different extract options in block 105. Upon a positive determination in block 105, the logical flow may proceed to block 106 where the assessment mechanism 14 converts the portfolio into the proper format required by the other program and stores the converted portfolio in a default file location. For example, the assessment mechanism 14 may extract the portfolio for use by other programs that may facilitate other related functions, such as collections, evaluations, analytics, account resales, and searches for accounts with bankrupt and/or deceased customers. If bankrupt or deceased customers are found, the buyer may contact the seller to indicate that these accounts should be removed. After extracting the portfolio in block 106, the logical flow may return to block 104 where the administrator can manage the selected portfolio. When the portfolio is satisfactory to the buyer, the seller may be notified and a contract initiated.

In this manner, using the assessment mechanism 14, the buyer is able to receive portfolios directly from sellers that have viewed the buyer's valuation of the portfolio before transmitting the portfolio to the buyer. If the buyer is satisfied with the account information in the portfolio from the seller, the buyer and seller have already agreed on a portfolio value, and price negotiations may not be necessary. In addition, the assessment mechanism 14 requires the seller to provide the required information that the buyer has identified in the forms of the assessment mechanism 14.

Upon a negative determination in block 105, the logical flow may return to block 100 where a determination is made as to whether the administrator wants to manage another portfolio.

Upon a negative determination in block 100, the logical flow may proceed to block 108 where a determination is made as to whether the administrator wants to manage the default file locations, which is where the assessment mechanism 14 stores extracted portfolios. If the administrator wants to change the default file locations, a positive determination is made in block 108 and the logical flow may proceed to block 110. In block 110, the assessment mechanism 14 allows the administrator to change the default file locations.

Upon a negative determination in block 108 or the completion of block 110, the logical flow may proceed to block 112 where a determination is made as to whether the administrator wants to manage the analytics and/or constants of the assessment mechanism 14. The assessment mechanism 14 stores the analytics and constants in the database 52. If the administrator wants to manage the analytics or constants, a positive determination is made in block 112 and the logical flow may proceed to block 114.

Block 114 of the assessment mechanism 14 allows the administrator to accomplish an analytics update, a region update, and/or an out-of-statute update. The analytics include the constants and current values associated with the logical analysis used by the assessment mechanism 14 to valuate a portfolio. The assessment mechanism 14 stores a history of analytics changes in the database 52 that is available for read-only review. To make updates easier, the assessment mechanism 14 allows the administrator to change analytics on a regional basis. For example, a region may be a group of states, and a region update may allow the administrator to modify the states that make up the region. An out-of-statute update allows the administrator to edit the constants in the assessment mechanism 14 for a particular state. Each state may have a different statute of limitations (SOL) for delinquent debt, which may be the time limit for a creditor to file a lawsuit. A debt is considered “out-of-statute” when the SOL has run for a particular delinquent debt.

After managing the analytics and/or constants of the assessment mechanism 14 in block 114, the logical flow may proceed to block 116 where a determination is made as to whether the administrator wants to post the analytics update. If the administrator wants to post the analytics update, a positive determination is made in block 116 and the logical flow may proceed to block 118, where the assessment mechanism 14 posts the update. When the assessment mechanism 14 posts the analytics update, a new version of the assessment mechanism 14 is made available for subsequent download by all users. Assessment mechanism 14 users can download the new version of the assessment mechanism 14 with the analytics update from the server 42 during an update process in block 63.

In another embodiment, the updates may be distributed from the buyer to the seller via a machine readable medium.

Upon a negative determination in block 112, a negative determination in block 116, or the completion of block 118, the logical flow may proceed to block 120 where a determination is made as to whether the administrator wants to manage the users of the assessment mechanism 14. The assessment mechanism 14 stores user information in the database 52. If the administrator wants to manage the users, a positive determination is made in block 120 and the logical flow may proceed to block 122. In block 122, the assessment mechanism 14 can create a chart including some or all of the following information for all users: username, first name, last name, email, active/inactive status, and last login date. The assessment mechanism 14 also allows the administrator to manage user and/or administrator settings, e.g., add/delete, edit, and/or configure access.

Upon a negative determination in block 120 or the completion of block 122, the logical flow may proceed to block 124 where a determination is made as to whether the administrator wants to reset passwords in the assessment mechanism 14. The assessment mechanism 14 stores passwords in the database 52. If the administrator wants to reset passwords, a positive determination is made in block 124 and the logical flow may proceed to block 126. In block 126, the administrator can, e.g., import a password data file, view a password data file, restore a user password, and/or clear all passwords.

Upon a negative determination in block 124 or the completion of block 126, the logical flow may proceed to block 128 where a determination is made as to whether the administrator wants to change the administrator profile in the assessment mechanism 14. The assessment mechanism 14 stores the administrator profile in the database 52. If the administrator wants to change the administrator profile, a positive determination is made in block 128 and the logical flow may proceed to block 130. In block 130, the administrator can change the administrator's profile, e.g., change the administrator password.

Upon a negative determination in block 128 or the completion of block 130, the logical flow may proceed to block 132 where a determination is made as to whether the administrator wants to logout of the assessment mechanism 14. If the administrator wants to logout, a positive determination is made in block 132 and the logical flow may proceed to block 134, where the assessment mechanism 14 exits. If the administrator does not want to logout, a negative determination is made in block 132 and the logical flow may return to block 100, where the assessment mechanism 14 provides the administrator with the administration options.

### F. ADDITIONAL FEATURES

In further embodiments, the assessment mechanism 14 may also include: a tutorial for training users and/or administrators how to use the assessment mechanism 14; a user manual for reference and assistance; and/or a provision for seller registration with the buyer before portfolio transmission.

### G. CONCLUSION

It will be appreciated that portions of the present invention can be implemented in hardware, software, firmware, or a combination thereof. In the described embodiment(s), a number of the steps or methods may be implemented in software or firmware that is stored in a memory and that is executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions or blocks in flow charts may be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The logic and/or steps represented in the flow diagrams of the drawings, which, for example, may be considered an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The above description and accompanying drawings depict the various features of the invention. It will be appreciated that the appropriate computer code could be prepared by a person who has ordinary skill in the art to carry out the various steps and procedures described above and illustrated in the drawings. It also will be appreciated that the various terminals, computers, servers, networks and the like described above may be virtually any type and that the computer code may be prepared to carry out the invention using such apparatus in accordance with the disclosure hereof.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

Although embodiments of the invention have been shown and described, it is understood that equivalents and modifications will occur to others in the art upon the reading and understanding of the specification. The present invention includes all such equivalents and modifications, and is limited only by the scope of the following claims.

What is claimed is:

1. A method of debt evaluation for acquisition, comprising:
providing a seller with an assessment mechanism for a debt portfolio;
receiving from the seller a proposed price and debt account information for the debt portfolio based on the use of the assessment mechanism; and
determining whether to acquire the debt portfolio based on the use of the assessment mechanism.

2. A computer implemented method of assessing a portfolio of debt accounts using an assessment mechanism, comprising:
collecting debt account information regarding at least one debt account;
storing the debt account information in an account record;
creating a debt portfolio, wherein the debt portfolio includes at least one debt account; and
valuating the debt portfolio, wherein a valuation results in a proposed price for the debt portfolio.

3. The method of claim 2, further comprising:
receiving an update for the assessment mechanism, wherein the update for the assessment mechanism is provided via at least one of a download from a network or a machine readable medium.

4. The method of claim 2, further comprising:
identifying individual users of the assessment mechanism using login credentials, wherein multiple users can access the assessment mechanism using the same machine and the assessment mechanism maintains separate user profiles and data files for each user.

5. The method of claim 2, wherein the debt account information is collected by at least one of importing a machine readable file containing the debt account information or obtaining information from user inputs into a machine readable form.

6. The method of claim 5, wherein the assessment mechanism provides the user a template for the machine readable file containing the debt account information.

7. The method of claim 5, further comprising:
providing warning messages when the machine readable file containing the debt account information includes questionable data, wherein the machine readable file containing the debt account information is imported and a warning log box is created to provide details of the warning messages; and
providing error messages when the machine readable file containing the debt account information includes incorrect or missing data, wherein the machine readable file containing the debt account information stops importing and an error log box is created to provide details of the error messages.

8. The method of claim 2, further comprising:
providing missing information messages when the account record is missing information.

9. The method of claim 2, wherein the account record is editable after the debt account information is collected.

10. The method of claim 2, wherein the valuation is at least one of a preliminary valuation or a transmittal valuation, wherein the preliminary valuation does not require all of the debt account information required for the transmittal valuation.

11. The method of claim 10, further comprising:
transmitting the transmittal valuation for the debt portfolio, wherein the transmittal valuation includes the proposed price and the debt account information for the debt portfolio.

12. A computer implemented method of assessing a portfolio of debt accounts using an assessment mechanism, comprising:
receiving a transmittal valuation for a debt portfolio, wherein the transmittal valuation includes the proposed price and the debt account information for the debt portfolio;
storing the transmittal valuation; and
managing the transmittal valuation, wherein managing includes at least one of viewing, searching, comparing, sorting, editing, calculating, extracting, or deleting.

13. The method of claim 12, further comprising:
providing an update for the assessment mechanism, wherein the update for the assessment mechanism is provided via at least one of a download from a network or a machine readable medium.

14. The method of claim 12, further comprising:
identifying individual users of the assessment mechanism using login credentials, wherein multiple users can access the assessment mechanism using the same machine and the assessment mechanism maintains separate user profiles, data files, and access for each user.

15. The method of claim 12, further comprising:
managing at least one of default file locations, profiles, users, or passwords; and
charting user information, wherein the user information includes at least one of user name, first name, last name, email, active/inactive, or last login.

16. A computer system for assessing a portfolio of debt accounts using an assessment mechanism, comprising a computer including at least one of a processor and a memory, configured to:
collect debt account information regarding at least one debt account;
store the debt account information in an account record;
create a debt portfolio, wherein the debt portfolio includes at least one debt account; and
valuate the debt portfolio, wherein a valuation results in a proposed price for the debt portfolio.

17. A computer system for assessing a portfolio of debt accounts using an assessment mechanism, comprising a computer including at least one of a processor and a memory, configured to:
receive a transmittal valuation for a debt portfolio, wherein the transmittal valuation includes the proposed price and the debt account information for the debt portfolio;
store the transmittal valuation; and
manage the transmittal valuation, wherein managing includes at least one of viewing, searching, comparing, sorting, editing, calculating, extracting, or deleting.

18. A program stored on a machine readable medium, the program for assessing a portfolio of debt accounts using an assessment mechanism and comprising executable logic to:
collect debt account information regarding at least one debt account;
store the debt account information in an account record;
create a debt portfolio, wherein the debt portfolio includes at least one debt account; and
valuate the debt portfolio, wherein a valuation results in a proposed price for the debt portfolio.

19. A program stored on a machine readable medium, the program for assessing a portfolio of debt accounts using an assessment mechanism and comprising executable logic to:
receive a transmittal valuation for a debt portfolio, wherein the transmittal valuation includes the proposed price and the debt account information for the debt portfolio;
store the transmittal valuation; and
manage the transmittal valuation, wherein managing includes at least one of viewing, searching, comparing, sorting, editing, calculating, extracting, or deleting.
